(19) United States
(12) Patent Application Publication
(10) Pub. No.: US 2019/0032695 A1
(43) Pub. Date: Jan. 31, 2019

(54) INTERNAL POSITIVE STOP, BREAK-OFF FLUSHNESS IN BLIND FASTENERS

(71) Applicant: SPS TECHNOLOGIES, LLC, Jenkintown, PA (US)

(72) Inventor: Terry Vovan, Upland, CA (US)

(73) Assignee: SPS TECHNOLOGIES, LLC, Jenkintown, PA (US)

(21) Appl. No.: 16/051,191

(22) Filed: Jul. 31, 2018

Related U.S. Application Data
(60) Provisional application No. 62/539,517, filed on Jul. 31, 2017.

(51) Int. Cl. F16B 19/10

(52) U.S. Cl. CPC F16B 19/1072; F16B 19/1063

(57) ABSTRACT

A blind fastener includes a core bolt and a core nut. The core bolt has a threaded section, a non-threaded section, a bolt head, and a stop shoulder. The non-threaded section is disposed axially between the threaded section and the bolt head. The stop shoulder is disposed axially between the threaded section and the non-threaded section. The core nut surrounds the core bolt and is threadably engaged with the threaded section of the core bolt. The core nut has an internal positive stop extending radially inward from an inner surface of the core nut. The positive stop of the core nut opposes the stop shoulder and cooperates with the stop shoulder to inhibit further tightening of the core bolt when the blind fastener is in a completely installed condition.

### CROSS-REFERENCE TO RELATED APPLICATIONS

This application claims priority to and the benefit of U.S. provisional application Ser. No. 62/539,517 filed on Jul. 31, 2017. The entire disclosure of the above-referenced application is incorporated herein by reference.

### FIELD

The present disclosure relates generally to fasteners, and more particularly to blind fasteners having a core bolt and a sleeve around the core bolt for connecting panels or workpieces.

### BACKGROUND

The statements in this section merely provide background information related to the present disclosure and may not constitute prior art.

A blind fastener is typically used to secure multiple panels together and to be installed from one side (i.e., a front or access side) of the panels. The blind fastener may include a core bolt and a sleeve surrounding the core bolt, which are inserted into a hole of the panels. A portion of the sleeve adjacent to a rear side of the panel is generally deformed during installation of the fastener. The deformed portion of the sleeve provides a bearing surface to induce preload in the fastener such that the panels can be clamped together.

After the deformed portion of the sleeve is formed, the core bolt may be rotated to provide a preload to the fastener. When the fastener is completely installed, a front portion of the core bolt may break off. The break-off point of the typical core bolt cannot be controlled. When the break-off point is located outside the countersunk head of the sleeve, a grinding or shaving operation is needed to make the break-off surface flush with the front panel, resulting in increased manufacturing costs. Moreover, the typical fastener does not include a torque control feature. When excessive torque is applied to the fastener, the sleeve of the fastener may flare out to form a “tulip” configuration, resulting in a defective installation.

### SUMMARY

In one form, a blind fastener includes a core bolt and a core nut. The core bolt has a threaded section, a non-threaded section, a bolt head, and a stop shoulder. The non-threaded section is disposed axially between the threaded section and the bolt head. The stop shoulder is disposed axially between the threaded section and the non-threaded section. The core nut surrounds the core bolt and is threadably engaged with the threaded section of the core bolt. The core nut has an internal positive stop extending radially inward from an inner surface of the core nut. The positive stop of the core nut opposes the stop shoulder and cooperates with the stop shoulder to inhibit further tightening of the core bolt when the blind fastener is in a completely installed condition.

According to a further form, the positive stop of the core nut abuts against the stop shoulder of the core bolt when the blind fastener is in the completely installed condition.

According to another form, the stop shoulder extends radially outward of the threaded section.

According to yet a further form, the stop shoulder and the positive stop are perpendicular to a central axis of the core bolt.

According to still another form, the core bolt includes a break-off groove that is aligned with a head of the core nut when the positive stop abuts the stop shoulder.

According to a further form, the break-off groove is disposed axially within the threaded section of the core bolt.

According to another form, the bolt head is disposed axially between the non-threaded section and the break-off groove.

According to yet another form, the break-off groove extends radially inward of a minor diameter of the threaded section.

According to still a further form, the blind fastener also includes a nut retainer non-rotatably coupled to a head of the core nut.

According to a further form, the core nut includes a head disposed on an axially opposite side of workpieces from the bolt head when the blind fastener is in the completely installed condition.

According to still another form, the core nut includes a head disposed on an axially same side of workpieces as the bolt head.

According to yet a further form, the blind fastener also includes a sleeve disposed about the non-threaded section of the core bolt. The core nut includes a ramp surface configured to engage an interior surface of a first end of the sleeve. The bolt head engages a second end of the sleeve.

According to still a further form, an outer surface of the core nut includes a plurality of serrations configured to engage the sleeve to inhibit rotation of the sleeve relative to the core nut.

According to still another form, the core bolt includes a break-off groove and the core nut includes a head. The break-off groove is a first axial distance from the head of the core nut and the positive stop is a second axial distance from the stop shoulder. The first and second distances are equal.

In another form, blind fastener assembly includes a set of workpieces, a core bolt and a core nut. The workpieces have a front side and a backside and define a bore that extends through the workpieces. The core bolt extends through the bore and includes a bolt head, a first non-threaded section, a first threaded section, a break-off groove, and a stop shoulder. The first non-threaded section is disposed axially between the first threaded section and the bolt head. The stop shoulder is disposed axially between the first threaded section and the first non-threaded section. The break-off groove is disposed axially within the first threaded section. The core nut includes a nut head, a second threaded section, a second non-threaded section, and a positive stop. The nut head is countersunk in the bore and extends radially outward of the second threaded section. The second threaded section is disposed axially between the head and the second non-threaded section. The positive stop radially overlaps with the stop shoulder. When the first and second threaded sections are threadably engaged, the break-off groove is a first axial distance from the head of the core nut and the positive stop is a second axial distance from the stop shoulder. The first and second distances are equal.

According to a further form, the positive stop of the core nut abuts against the stop shoulder of the core bolt when the blind fastener is in a completely installed condition.

According to still a further form, the blind fastener also includes a sleeve disposed about the first non-threaded section. The core nut includes a ramp surface configured to engage an interior surface of a first end of the sleeve. The bolt head engages a second end of the sleeve.

According to yet another form, an outer surface of the core nut includes a plurality of serrations configured to engage the sleeve to inhibit rotation of the sleeve relative to the core nut.

In another form, a method of fastening workpieces with a blind fastener having a core bolt and a core nut threadably engaged with the core bolt includes inserting a first end of the blind fastener through an aperture in the workpieces and rotating the core bolt in a first rotational direction relative to the core nut to deform either the core nut or a sleeve disposed between the core nut and a head of the bolt. The method includes continuing to rotate the core bolt in the first rotational direction until a stop shoulder of the core bolt abuts a positive stop of the core nut. The method includes continuing to rotate the core bolt in the first rotational direction until the core bolt breaks at a break groove axially aligned with a head of the core nut.

According to a further form, the break groove is a first axial distance from an axially outward facing surface of the head of the core nut and the stop shoulder is a second axial distance from the positive stop. The first and second distances are equal.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The present disclosure will become more fully understood from the detailed description and the accompanying drawings, wherein:

FIG. 1 is a perspective view of a blind fastener in accordance with the teachings of the present disclosure;

FIG. 2 is an exploded perspective view of the blind fastener of FIG. 1;

FIG. 3 is a perspective view of the blind fastener of FIG. 1 inserted through workpieces or panels to be connected;

FIG. 4 is a cross-sectional view of the blind fastener and workpieces or panels of FIG. 3;

FIG. 5 is a schematic side view of a portion of a core bolt of the blind fastener of FIG. 1;

FIG. 6 is a cross-sectional view similar to FIG. 4, illustrating the blind fastener in a partially installed condition;

FIG. 7 is a perspective view of the blind fastener and workpieces or panels of FIG. 3, illustrated in a fully installed condition;

FIG. 8 is a cross-sectional view of the blind fastener and workpieces of FIG. 7, illustrating minimum and maximum grip lengths of the workpieces;

FIG. 9 is a perspective view of fasteners, where some of the fasteners are in a defective installation condition with a “tulip” configuration;

FIG. 10 is a side view of a blind fastener of a second construction in accordance with the teachings of the present disclosure, illustrated in a pre-installed condition;

FIG. 11 is a top view of the blind fastener of FIG. 10;

FIG. 12 is a partial cross-sectional view of a blind fastener of a third construction in accordance with the teachings of the present disclosure, illustrated in a pre-installed condition;

FIG. 13 is a top view of the blind fastener of FIG. 12;

FIG. 14 is a cross-sectional view of a blind fastener of a fourth construction in accordance with the teachings of the present disclosure, illustrated in a completely installed condition; and

FIG. 15 is a photograph of sectioned blind fasteners lacking a positive stop and a stop shoulder in their installed conditions.

Corresponding reference numerals indicate corresponding parts throughout the several views of the drawings.

### DETAILED DESCRIPTION

The following description is merely exemplary in nature and is not intended to limit the present disclosure, application, or uses.

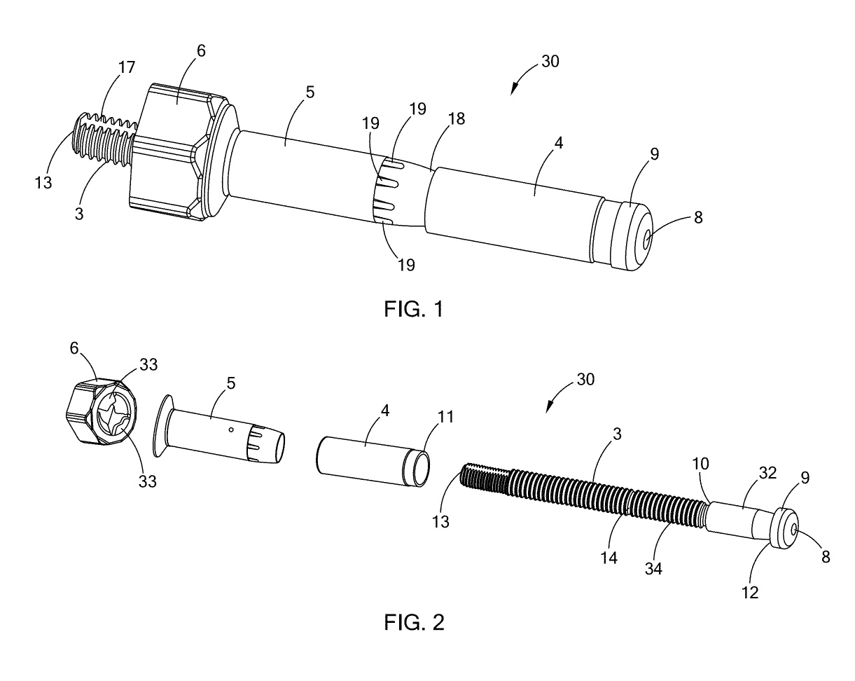

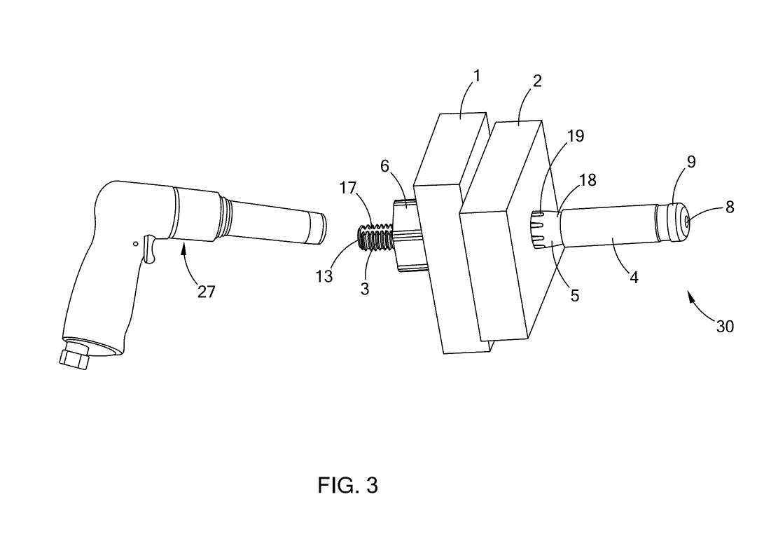

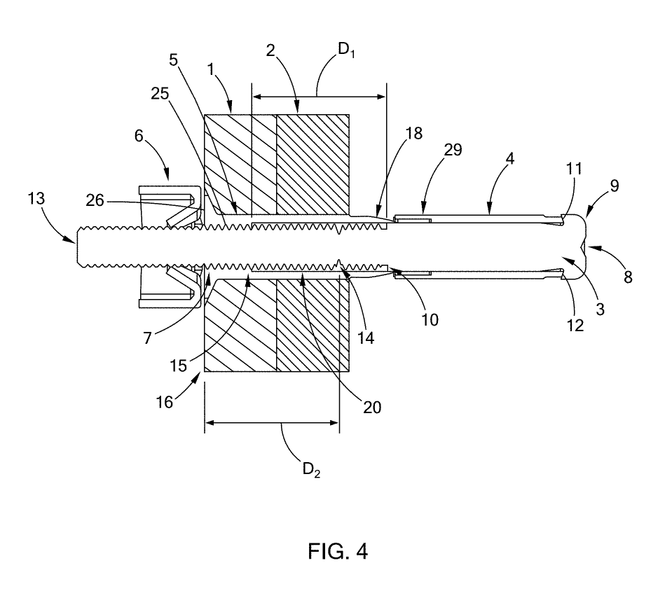

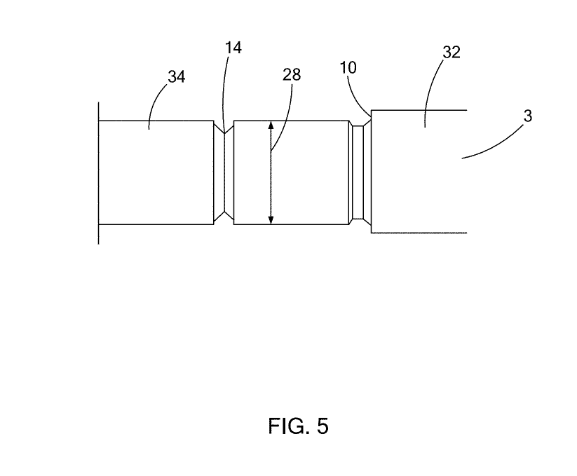

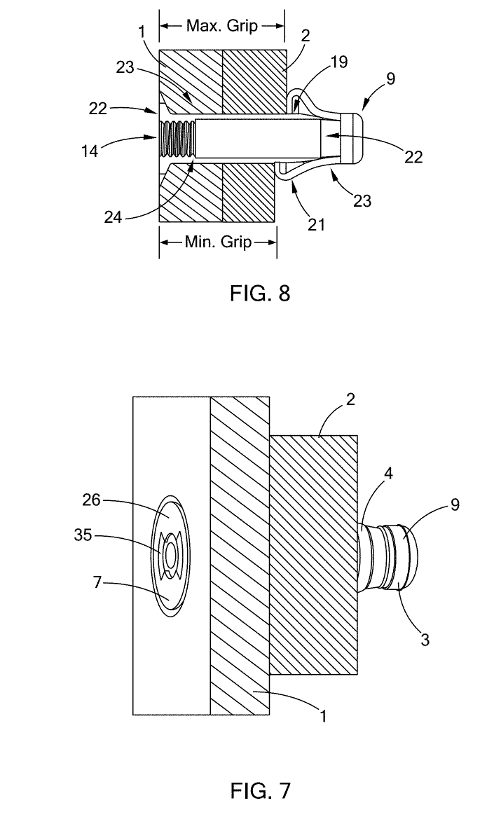

Referring to FIGS. 1 to 8, a blind fastener 30 according to the present disclosure is used to attach a front panel 1 to a rear panel 2 and is inserted into a through hole of the front and rear panels 1 and 2. The fastener 30 includes a core bolt, or stem, 3, a core nut 5 surrounding a middle portion of the core bolt 3, and a sleeve 4 surrounding a rear portion of the core bolt 3. A nut retainer 6 may be optionally attached to a front head of the core nut 5 for inhibiting the core nut 5 from rotating during installation. The nut retainer 6 is optional and may be eliminated if a tool (e.g., tool 27) is attached directly to the core bolt 3 or the core nut 5 for the same purpose. In the example provided, the nut retainer 6 is a hexagonal nut, though other configurations can be used. In the example provided, the nut retainer 6 has tangs 33 that extend axially into recesses 35 (shown in FIG. 7) in the forward surface 26 of the head 7 of the core nut 5 to non-rotatably couple the head 7 to the nut retainer 6. The core bolt 3 has a drilled recess 8 at a core bolt head 9 to facilitate the removal process of the fastener 30 at the end of the product lifecycle by drilling out the fastener 30.

The core bolt 3 has a non-threaded (e.g., smooth cylindrical) section 32, a threaded section 34, and a core bolt stop shoulder 10 disposed therebetween. In the example provided, the stop shoulder 10 extends radially outward of the major diameter 28 of the threaded section 34. The sleeve 4 is a generally cylindrical body. One end of the sleeve 4 has a counterbore 29. The other end of the sleeve 4 defines a smooth rotational surface 11. The non-threaded section 32 and head 9 of the core bolt 3 define a smooth rotational surface 12 in contact with the smooth rotational surface 11 of the sleeve 4. The smooth rotational surface 12 of the core bolt 3 and the smooth rotational surface 11 of the sleeve 4 function as a rotating bearing surface, which may be lubricated, when a front end 13 of the core bolt 3 is tightened by screwing or unscrewing of the core bolt 3. In the example provided, the front end 13 of the core bolt 3 can be screwed or unscrewed by gripping a pair of flat surfaces 17 on the front end 13.

A break-off groove 14 is provided at the threaded section 34 of the core bolt 3 and between the core bolt stop shoulder 10 and the front end 13. The break-off groove 14 constitutes a weaker point at the core bolt 3 so that the core bolt 3 can be broken at the break-off groove 14 when a torsional force is applied to a thread-type fastener or when a pulling force is applied to a pull-type fastener. In the example provided, the break-off groove 14 extends radially inward of the minor diameter of the threaded portion 34 and forms a minimum diameter of the core bolt 3.

The core nut 5 includes a head 7, a threaded section 25, and a counterbored section 20. The head 7 forms the front side of the core nut 5 and extends radially outward from the threaded section 25 and has an axially outward facing front surface 26 that faces away from the panels 1 and 2. The threaded section 34 of the core bolt 3 is threadably engaged with the threaded section 25 of the core nut 5. The core nut has a positive stop shoulder 15 axially between the threaded section 25 and the counterbored section 20. The stop shoulder 15 extends radially inward of the cylindrical inward facing surface of the counterbored section 20, which is radially outward of the minor diameter of the threaded section 25 of the core nut 5. By rotating the core bolt front end 13 in the tightening direction, the core bolt 3 moves in the axial direction such that the stop shoulder 10 moves toward the stop shoulder 15. The core bolt 3 can be tightened until the stop shoulder 10 comes to a positive stop and abuts against the core nut stop shoulder 15, and the break-off groove 14 is also simultaneously aligned with the front surface/side 16 of the front panel 1 or the front surface 26 of the countersunk head 7 of the core nut 5. In the example provided, the stop shoulders 10 and 15 are surfaces that oppose each other and are perpendicular to the central axis of the fastener 30.

A radially outer surface of the core nut 5 has a ramp 18 at the opposite axial end as the head 7. During initial installation, the head 9 of the core bolt 3 pushes the counterbore 29 of the sleeve around the ramp 18. The radially inward facing surface of the counterbore 29 slides along the ramp 18 and the sleeve 4 expands and covers the core nut ramp 18, and slides toward the rear surface of the rear panel 2. The outer surface of the counterbored section 20 of the core nut 5 includes radial serrations 19. The radial core nut serrations 19 on the core nut 5 body inhibit the sleeve 4 from freely rotating during the initial installation, but permit the sleeve 4 to slide axially on the core nut 5. The break-off groove 14 and the external threads of the core bolt 3 are disposed inside the counter bore 20 of the core nut 5. Before complete installation of the fastener 30, the break-off groove 14 and the external threads of the core bolt 3 are disposed inside the counterbore 20 of the core nut 5 and are inhibited against damage by any external force. The break-off groove 14 and the external threads of the core bolt 3 may be lubricated or sealants may be applied.

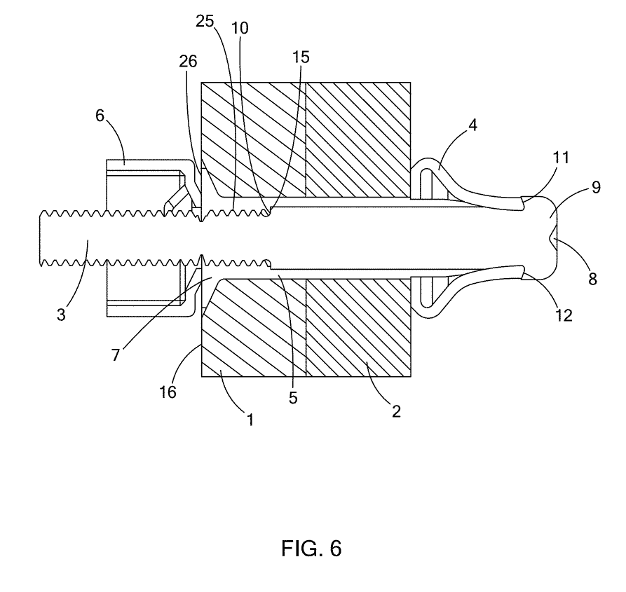

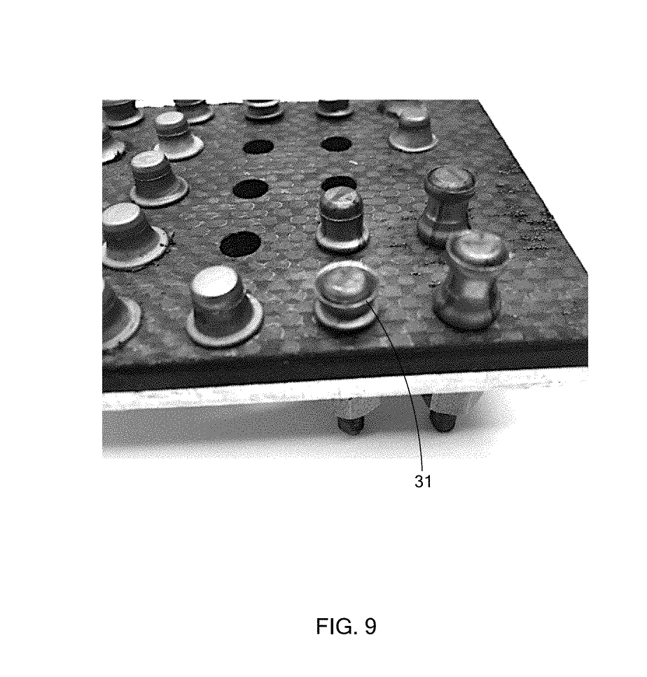

When the sleeve 4 is slid over the core nut ramp 18, the sleeve 4 is deformed, forming a bulb portion 21, as shown in FIGS. 6-8. The core nut serrations 19 inhibit the sleeve 4 from rotating during the installation. The bulb portion 21 may have a convex configuration depending on the total grip length of the panels 1 and 2. The size of the bulb portion 21 may be varied depending the grip length, which is equal to the thickness of the combined panels 1 and 2 to be connected. In the example provided, the core bolt 3 includes a recess groove 22 provided adjacent to the rotational surface 12 of the core bolt 3 to facilitate the sleeve front 23 to cave into the recess groove 22 to avoid a defective “tulip” condition, i.e., the sleeve front 23 flaring out, as shown at reference numeral 31 in FIG. 9

Because the internal positive stop 24 is provided between the core bolt 3 and the core nut 5, the bulb portion 21, in a tensile linear stage, is not in a fully compressed position. Therefore, the bulb portion can provide a higher tensile preload in keeping the panels together in a high frequency of vibration.

Moreover, the internal positive stops 10 and 15 between the core bolt 3 and the core nut 5 allow the fastener to reach a desired panel thickness, preferably an average distance between maximum and minimum panel thicknesses. The core bolt 3 shall break-off flush with the countersunk head 7 of the core nut 5 during the installation. This positive stop can precisely regulate the break-off position of the core bolt 3 of the fastener 10, to ensure it would not exceed the tolerances of protrusion or recess of the mounting panel 1 or the countersunk head. In the example provided, the break-off position is regulated by the distance D1 between the stops 10 and 15 being equal to the distance D2 between the break-off groove 14 and the head 7 (e.g., at the front surface 26) of the core nut 5. D1 remains equal to D2 at all times when the core bolt 3 is threadably engaged with the core nut 5.

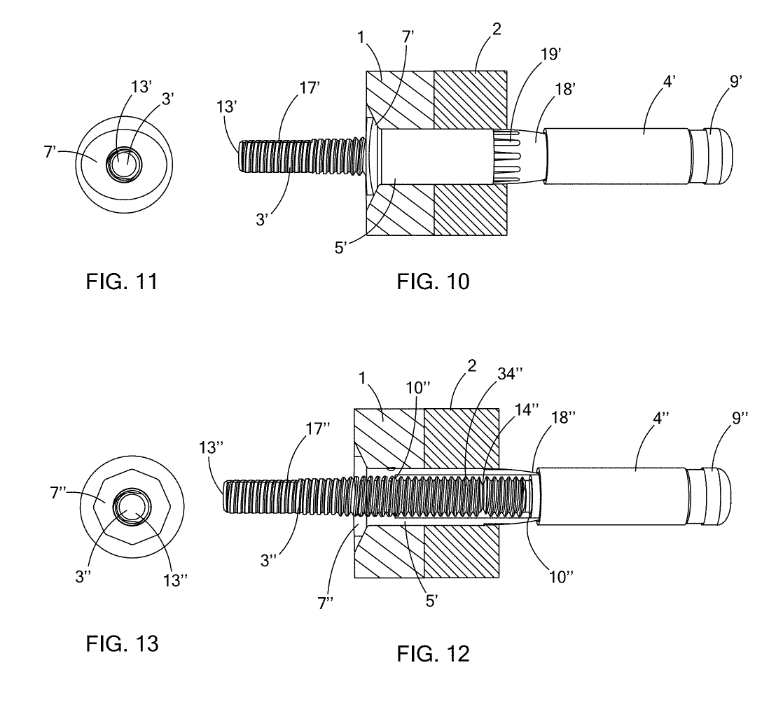

With reference to FIGS. 10 and 11, a blind fastener 30′ is illustrated. The blind fastener 30′ is similar to the blind fastener 30, except as otherwise shown or described herein. Similar features are denoted with similar but primed reference numerals and only differences are described herein in detail. In the example provided, the head 7′ is configured to be directly engaged by a tool without the nut retainer 6. The nut head 7′ has a generally ovoid shape that is smaller than the round counter sink of the hole in the top panel 1, such that a tool having a matching ovoid shape can be received in the counterbore of the hole and grip the head 7′ to inhibit rotation of the core nut 5′.

With reference to FIGS. 12 and 13, a blind fastener 30″ is illustrated. The blind fastener 30″ is similar to the blind fastener 30 and 30′, except as otherwise shown or described herein. Similar features are denoted with similar but double-primed reference numerals and only differences are described herein in detail. In the example provided, the head 7″ is configured to be directly engaged by a tool without the nut retainer 6. The nut head 7″ has a generally polygonal shape (e.g., hexagonal) that is smaller than the round counter sink of the hole in the top panel 1, such that a tool having a matching polygonal shape (e.g., hexagonal) can be received in the counterbore of the hole and grip the head 7″ to inhibit rotation of the core nut 5″.

Referring to FIG. 14, an alternative form of a blind fastener 50 is shown. In this configuration, the blind fastener 50 includes a core bolt 51 and a core nut 52. The core bolt 51 includes a head 53, a non-threaded section 54, and a threaded section 55. The non-threaded section 54 is axially between the head 53 and the threaded section 55. The head 53 is axially between the break-off groove (not shown) and the non-threaded section 54. The end of the non-threaded section 54 forms a stop shoulder 56 between the non-threaded section 54 and the threaded section 55. The non-threaded section 54 and the stop shoulder 56 extend radially outward of the major diameter of the threaded section 55.

The core nut 52 includes a countersunk head 57, a non-threaded section 58, and a threaded section 59. The head 57 is received in a countersunk region of the hole in the top panel 1. The head 53 of the core bolt 51 is received in the head 57 of the core nut 52 and the front surfaces of the heads 53 and 57 are flush. The threaded section 55 of the core bolt 51 and the threaded section 59 are threadably engaged on the back side of the panels 1 and 2. The interior cylindrical surface of the non-threaded section 58 has a diameter that is greater than the major diameter of the threaded sections 55 and 59. A positive stop 60 extends radially inward from the interior surface of the non-threaded section 58, such that the position stop 58 is provided at an inner surface of the core nut 52 to regulate or restrain the axial movement of the core bolt 51 by causing the positive stop 60 to engage the shoulder stop 56 during installation. The stops 56 and 60 inhibit further rotation of the core bolt 51 at a point when the non-threaded section 58 has formed a bulb portion 61 against the back side of the rear panel 2, but while the bulb portion 61 is in a tensile linear stage and not in a fully compressed position. Therefore, the bulb portion 61 can provide a higher tensile preload in keeping the panels together in a high frequency of vibration.

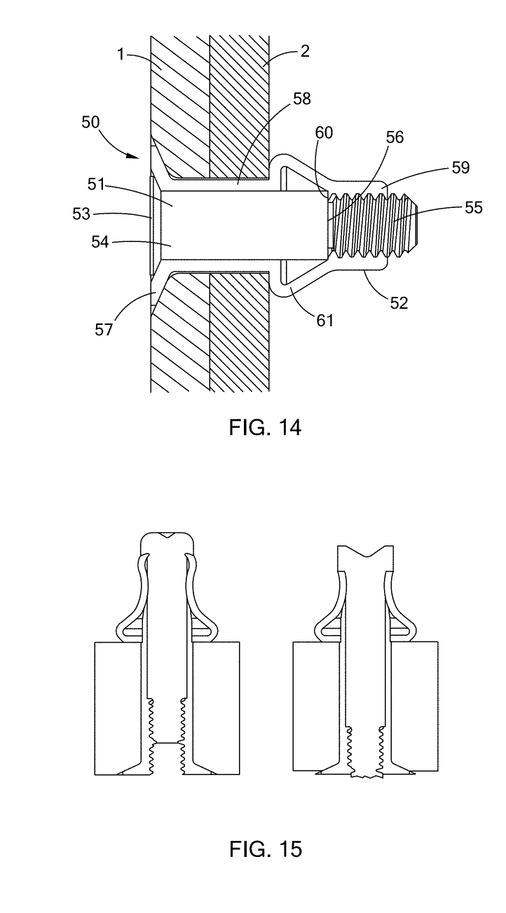

Referring to FIG. 15, the fastener of the present disclosure eliminates secondary work that would otherwise be required in a fastener without such positive stops, such as grinding, shaving, sanding, and filling in the front side of the fastener. As shown in FIG. 15, a fastener without such positive stops may result in a break-off end being disposed inside the countersunk end of the core nut or protruding outside the countersunk end of the core nut. Therefore, the secondary work to grind, shave, sand, and fill in the front side of such a fastener would typically be required. This process requires a lot of labor, time, and costs, thereby increasing manufacturing costs, which can be particularly significant in the aerospace industry where approximately 8,000 to 10,000 fasteners are used in each commercial aircraft. Therefore, the fastener of the present disclosure can shorten the manufacturing time and reduce the manufacturing costs, since no secondary work is required to treat the front surface of the fastener.

Another benefit of the fastener of the present disclosure is that it reduces rejections of inconsistent break-off from the core-bolt/stem, which would otherwise rely upon a perfect manufacturing processing condition to achieve the precise nominal hardness value (tight tolerance) of the core-bolt/stem. In other words, the fasteners of the present disclosure accommodate larger part and assembly tolerances, thereby allowing a wider range of grip lengths. Furthermore, the fastener of the present disclosure provides an aesthetic flush mounting and optimizes aerodynamic appearance.

The fastener of the present disclosure also provides a higher preload (compression pressure of the sandwiched mounting panels), which can be about 50% of the tensile strength of the installed fastener (e.g., half the tensile strength needed to sheer the threads of the fastener). Typical blind fasteners currently on the market are fully compressed/deformed when installed, which offers less preload value. Higher preload values provided by the fastener of the present disclosure are significantly beneficial in handling the high-frequency vibrations of aircraft, in both threaded-type blind fasteners and pull-type blind rivets.

The fastener of the present disclosure also inhibits over torque/pulling that would create a lower preload value and defective installation due to a “tulip” configuration.

It should be noted that the disclosure is not limited to the embodiment described and illustrated as examples. A large variety of modifications have been described and more are part of the knowledge of the person skilled in the art. These and further modifications as well as any replacement by technical equivalents may be added to the description and figures, without leaving the scope of the protection of the disclosure and of the present patent.

What is claimed is:

1. A blind fastener comprising:
a core bolt having a threaded section, a non-threaded section, a bolt head, and a stop shoulder, the non-threaded section being disposed axially between the threaded section and the bolt head, the stop shoulder being disposed axially between the threaded section and the non-threaded section; and
a core nut surrounding the core bolt and threadably engaged with the threaded section of the core bolt, the core nut having an internal positive stop extending radially inward from an inner surface of the core nut, the positive stop of the core nut opposing the stop shoulder and cooperating with the stop shoulder to inhibit further tightening of the core bolt when the blind fastener is in a completely installed condition.

2. The blind fastener according to claim 1, wherein the positive stop of the core nut abuts against the stop shoulder of the core bolt when the blind fastener is in the completely installed condition.

3. The blind fastener according to claim 1, wherein the stop shoulder extends radially outward of the threaded section.

4. The blind fastener according to claim 1, wherein the stop shoulder and the positive stop are perpendicular to a central axis of the core bolt.

5. The blind fastener according to claim 1, wherein the core bolt includes a break-off groove that is aligned with a head of the core nut when the positive stop abuts the stop shoulder.

6. The blind fastener according to claim 5, wherein the break-off groove is disposed axially within the threaded section of the core bolt.

7. The blind fastener according to claim 5, wherein the bolt head is disposed axially between the non-threaded section and the break-off groove.

8. The blind fastener according to claim 5, wherein the break-off groove extends radially inward of a minor diameter of the threaded section.

9. The blind fastener according to claim 1, further comprising a nut retainer non-rotatably coupled to a head of the core nut.

10. The blind fastener according to claim 1, wherein the core nut includes a head disposed on an axially opposite side of workpieces from the bolt head when the blind fastener is in the completely installed condition.

11. The blind fastener according to claim 1, wherein the core nut includes a head disposed on an axially same side of workpieces as the bolt head.

12. The blind fastener according to claim 1, further comprising a sleeve disposed about the non-threaded section of the core bolt, wherein the core nut includes a ramp surface configured to engage an interior surface of a first end of the sleeve, wherein the bolt head engages a second end of the sleeve.

13. The blind fastener according to claim 12, wherein an outer surface of the core nut includes a plurality of serrations configured to engage the sleeve to inhibit rotation of the sleeve relative to the core nut.

14. The blind fastener according to claim 1, wherein the core bolt includes a break-off groove and the core nut includes a head, wherein the break-off groove is a first axial distance from the head of the core nut and the positive stop is a second axial distance from the stop shoulder, the first and second distances being equal.

15. A blind fastener assembly comprising:
a set of workpieces having a front side and a back side, the workpieces defining a bore that extends through the workpieces;
a core bolt extending through the bore, the core bolt including a bolt head, a first non-threaded section, a first threaded section, a break-off groove, and a stop shoulder, the first non-threaded section being disposed axially between the first threaded section and the bolt head, the stop shoulder being disposed axially between the first threaded section and the first non-threaded section, the break-off groove being disposed axially within the first threaded section; and
a core nut including a nut head, a second threaded section, a second non-threaded section, and a positive stop, the nut head being countersunk in the bore and extending radially outward of the second threaded section, the second threaded section being disposed axially between the head and the second non-threaded section, the positive stop radially overlapping with the stop shoulder,
wherein when the first and second threaded sections are threadably engaged, the break-off groove is a first axial distance from the front side of the workpieces and the positive stop is a second axial distance from the stop shoulder, the first and second distances being equal.

16. The blind fastener assembly of claim 15, wherein the positive stop of the core nut abuts against the stop shoulder of the core bolt when the blind fastener is in a completely installed condition.

17. The blind fastener assembly according to claim 15, further comprising a sleeve disposed about the first non-threaded section, wherein the core nut includes a ramp surface configured to engage an interior surface of a first end of the sleeve, wherein the bolt head engages a second end of the sleeve.

18. The blind fastener assembly according to claim 17, wherein an outer surface of the core nut includes a plurality of serrations configured to engage the sleeve to inhibit rotation of the sleeve relative to the core nut.

19. A method of fastening workpieces with a blind fastener having a core bolt and a core nut threadably engaged with the core bolt, the method comprising:
inserting a first end of the blind fastener through an aperture in the workpieces;
rotating the core bolt in a first rotational direction relative to the core nut to deform either the core nut or a sleeve disposed between the core nut and a head of the bolt;
continuing to rotate the core bolt in the first rotational direction until a stop shoulder of the core bolt abuts a positive stop of the core nut; and
continuing to rotate the core bolt in the first rotational direction until the core bolt breaks at a break groove axially aligned with a head of the core nut.

20. The method of claim 19, wherein the break groove is a first axial distance from an axially outward facing surface of the head of the core nut and the stop shoulder is a second axial distance from the positive stop, the first and second distances being equal.
